(19) United States
(12) Patent Application Publication
(10) Pub. No.: US 2010/0161384 A1
(43) Pub. Date: Jun. 24, 2010

(54) System and Method for Presenting Content

(76) Inventor: Matthew D. WELLS, Bernalillo, NM (US)

Correspondence Address: WILMERHALE/BOSTON, 60 STATE STREET, BOSTON, MA, 02109, US

(21) Appl. No.: 12/637,216

(22) Filed: Dec. 14, 2009

Related U.S. Application Data
(60) Provisional application No. 61/138,627, filed on Dec. 18, 2008.

(51) Int. Cl. G06F 15/16; G06Q 10/00; G06Q 30/00; G06Q 50/00; H04N 7/173

(52) U.S. Cl. 705/10; 709/203; 705/14.53; 705/14.44; 725/109

(57) ABSTRACT

A computer-implemented system and method is disclosed and described for presenting content, including but not limited to, news content, to a computer-based System User in a converted audio and/or video presentation form. In more detail, the computer-implemented system and method is for gathering news content to substantially match a System User's (reader's) interests and converting this news content into high quality audio and video presentations for consumption by the System User.

### RELATED APPLICATION

This application claims the benefit under 35 U.S.C. §119(e) of U.S. Provisional Patent Application No. 61/138,627, filed on Dec. 18, 2008, entitled System And Method For Presenting Content, which is herein incorporated by reference in its entirety.

### FIELD OF INVENTION

The present invention relates generally to computer-based systems and methods for data mining, information retrieval, personalization, social media uses, multimedia uses, crowdsourcing, online news uses, and search engines. More specifically, the present invention relates to computer-based systems and methods relating to the presentation of content associated with data mining, information retrieval, personalization, social media uses, multimedia uses, crowdsourcing, online news uses, and search engines.

### BACKGROUND OF THE INVENTION

Some of the more popular sources of online news content are websites of traditional or mainstream news companies, weblogs (“blogs”), and news aggregators. Typically, news aggregator websites are websites that mine news from other websites, and then rank and filter the news before presenting it to end-user readers.

News aggregator websites may include filters for presenting news deemed the most relevant for each particular end-user reader. This form of news personalization allows generic news aggregators to compete with the many niche or specialized news sites. Topix.com and Google News are systems that incorporate such news personalization. “Topix” is a registered trademark of Topix, LLC and “Google” is a registered trademark of Google, Inc.

Generally, “crowdsourcing” is understood to mean the act of using the general public to do research or other work, which may or may not be paid for. The concept and use of crowdsourcing predates the Internet. For example, early crowdsourcing resulted in dictionaries that were assembled by individuals or groups from many small volunteer contributions. However, the Internet has proved to be a practical medium for crowdsourcing projects because of its wide ranging scope and public use. According to the website http://en.wikipedia.org/wiki/Crowdsourcing, applications like “Wikipedia” and “YouTube” are two of the more successful crowdsourced products. “Wikipedia” is a registered trademark of the Wikipedia Foundation, Inc. and “YouTube” is a registered trademark of Google, Inc. With regard to news, according to the website http://www.wired.com/software/webservices/news/2006/11/7206, publishers like Garnett have viewed crowdsourcing as an internal news-gathering vehicle.

A review of the website Vocalo.org indicates that user-created content may be broadcast, for example, in the form of blogs over the airwaves. The content broadcast by Vocalo.org is described at http://en.wikipedia.org/wiki/Vocalo.org as follows:
Vocalo.org is a radio station and virtual community created by Chicago Public Radio. It is the only radio station that uses user generated content to fill the majority of its playtime. It is currently broadcast on WBEW (89.5 FM) in Northwest Indiana and has announced plans to expand its signal to include Chicago by spring of 2008. The station plays material made by community members using a crowd sourcing model.
Vocalo.org hosts play content that listeners upload to the Vocalo.org website (which includes: personal stories, news items, music, interviews, commentary, fiction, poetry, comedy, etc.), by encouraging submissions through community training programs, providing access to equipment, and by teaching people how to use their telephones to record and submit pieces to the station.

However, these prior systems and methods do not deliver personalized or specialized news as mined from niche or specialized data sources on the Internet as high quality video or audio presentations, similar to the nightly news on television. Thus, there remains a need for the delivery of such personalized or specialized news content based on the receipt of crowdsourced content. The present invention overcomes these problems of such prior systems and methods and provides such presentations.

### SUMMARY OF THE INVENTION

The present invention is a computer-implemented system and method for presenting information content, including but not limited to, news content, to computer-based System Users. In more detail, the present invention is a computer-implemented system and method for gathering news content to substantially match a System User's (reader's) interests and converting this news content into high quality audio and video presentations for listening or viewing by System Users. By using this present invention, System Users can listen to or view high quality audio or video presentations of their personalized news content on a device such as a radio, iPod, television, computer, or other multimedia device. “iPod” is a registered trademark of Apple, Inc. It is understood that video presentations include other types of visual presentations which are also considered to be within the scope of the present invention.

In a preferred embodiment of the present invention, a System User's computer-based system may be used to select news content, for example, in the form of news stories, of interest using a news or other type of search engine. This selection process may be based on a variety of criteria including, but not limited to, news content the System User viewed in the past, ratings the System User has assigned to news content, search queries the System User has performed, news content viewed by other similarly situated System Users, or news topics of interest.

The System User's selection criteria for news content of interest also includes prioritization criteria which may be based on one or more criteria, such as freshness of the news content or relevance of the news content to the System User's interests. Selection prioritization also may be based on search engine queries or news content on a particular list of sites or types of sites, such as blogs, mainstream media, forums, or message boards. The selection prioritization also may be based on criteria associated with the publisher of the news content, including public comment relating to the publisher, e.g., a particular publisher has been known to provide accurate, factually based news content. Hereinafter, selection criteria is understood to include prioritization criteria.

After the selection for displaying news content, such as content in the forms of news stories, have been determined according to the above process, the System User's selection criteria is uploaded or otherwise provided to a central system server that will transmit this information to an electronically connected system database. This information periodically updates the system database to reflect the number of System Users that have selected particular news content based on the selection criteria. The summation of this information will generate the “demand count” for particular news content.

The demand count will be made available to potential presenters through, for example, a website on the Internet. Presenters are individuals who access the Internet and elect to create presentations for particular news content. These presentations will provide crowdsourcing for news content according to the system and method of the present invention. Preferably, the presentations that are created by presenters will be high quality audio or video presentations of the news content.

The selection by presenters of news content to make into presentations preferably will be according to the demand count. The presenter will upload these presentations to a central system server. The presenters may also translate a news content presentation from one language to another before uploading it to the central system server.

If the original publisher of specific news content has granted reproduction rights to presenters with regard to such news content, a presenter's presentation may be made available, for example, on an Internet website for the System User's reading or listening. The System User may view or listen to the presentation on this website, manually download the presentation, or have the presentation automatically downloaded to the System User's replay device.

Presenters and their presentations, like publishers of news content, may be ranked and voted on by System Users. Therefore, if there is more than one presenter for specific news content, the presentation that receives the most votes would be ranked highest as the most preferred, as would the presenter that received the most votes ranking his/her presenting qualities relating to presenting news content. The criteria for ranking presenters and presentations may vary depending on the System User. This is another crowdsourcing element of the present invention.

According to the present invention, publishers and presenters of news content can receive remuneration based on advertising revenues from advertisements associated with particular news content presentations. These advertisements are uploaded to the central server system by advertisers and these will be associated with the news content presentations desired by the advertiser. There may be various methods by which the publisher and presenters may share advertising revenues and still be within the scope of the present invention.

The system and method of the present invention will now be described in greater detail in the remainder of the specification referring to the drawings.

### BRIEF DESCRIPTION OF THE DRAWINGS

FIG. 1 shows a representative drawing to the system of the present invention.

FIG. 2 shows a representative drawing of the news content (stories) of interest for System Users based on selection criteria.

FIG. 3 shows a representative partial table of the demand count for (news content) by System Users.

FIG. 4 shows a flow diagram according to the method of the present invention.

### DETAILED DESCRIPTION OF THE INVENTION

The present invention is a computer-implemented system and method for presenting content, including but not limited to, news content, to a computer-based System User. More specifically, the present invention provides a system and method for gathering news content that substantially matches a System User's (reader's) interests and converts this news content into high quality audio and video presentations for reading or listening to by the System User. These specialized presentations may be viewed or listened to by the System User using a replay device, such as a radio, iPod, television, computer, personal digital assistant (PDA), or other multimedia device. For purposes of the present invention, “content” means “news content,” including news stories, or other types of information content that may be available over the Internet, an intranet, or electronic-based network; all of which are within the scope of the present invention.

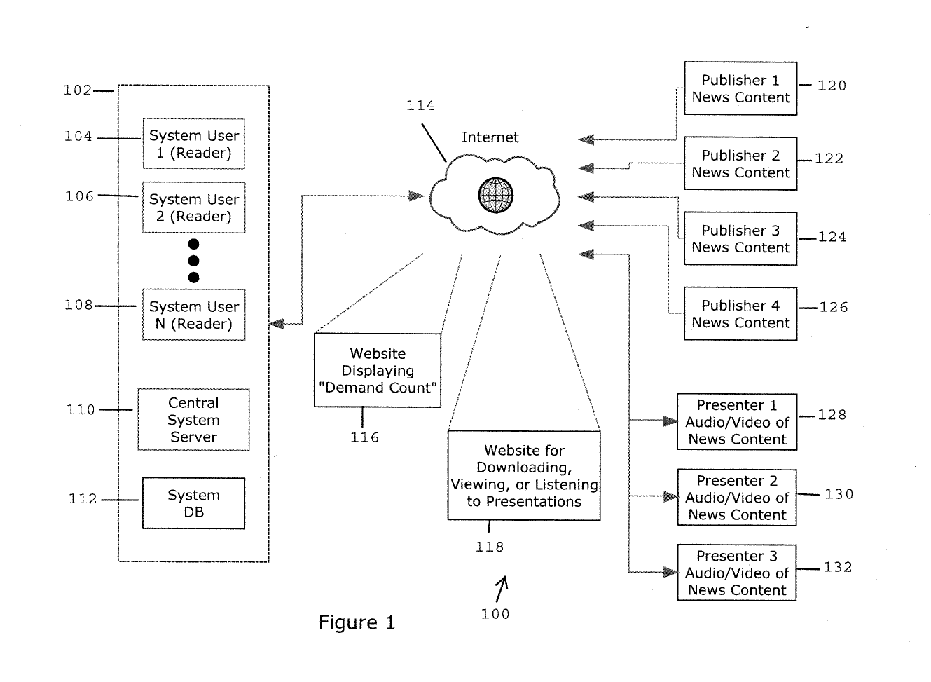

Referring to FIG. 1, generally at 100, a representative drawing of the system of the present invention is shown. Generally at 102, computer-based System Users 1 to N are shown associated with central system server 110 and system database 112. By way of example, FIG. 1 shows System User 1 at 104, System User 2 at 106, and System User N at 108. It is understood that System User N represents a large plurality of System Users that may be using system and method of the present invention at any given point in time. Further, it is understood that each of the System Users shown generally at 102 represents one or more System Users that electronically connect to the Internet, an intranet, or other electronic-based network using a conventional compatible device, such as a computer, cellular phone, PDA, or similar device. These connections may be wired or wireless and still be in the scope of the present invention. For purposes of explaining the present invention, the System User devices may be connected to Internet 114 through separate connections or group connections using an ISP (Internet Service Provider) and still be within the scope of the present invention. Moreover, the System Users may connect to the central system server 110 through Internet 114 or directly using separate or group wired or wireless electronic connections.

As stated, central system server 110 has system database 112 associated with it for purposes of carrying out the method of the present invention. Central system server 110, among other things, is for receiving uploaded (i) news content requests from the System Users relating to their news content of interest based on selection criteria, (ii) presentations from presenters, and (iii) advertisements for associating with news content presentations. Central system server 110 transmits the uploaded news content requests from System Users to system database 112 for processing. System database 112 will process the System User news content requests to generate a demand count that shows System User preferences for potential presenters to consider in determining news content for which presentations will be created.

Preferably, System Users 1 to N will have access to news content via the Internet 114; however, it is understood that System Users 1 to N may access news content other than through the Internet, such as television and newspapers, and still be within the scope of the present invention. This news content will be from news publishers, such as Publisher 1 at 120, Publisher 2 at 122, Publisher 3 at 124, and Publisher 4 at 126. This news content may vary in scope and be directed to a variety of news topics. It is understood that although only four publishers are shown, more or less than four publishers may provide news content for access by the System Users and still be within the scope of the present invention.

When System Users 1 to N view news content, for example, from Publishers 1 to 4, each will have his/her own interest in particular news content for which he/she would like to listen or view as a crowdsourced presentation. The System Users may select this news content of interest with his/her selection criteria using conventional search engine techniques by making search requests on Internet 114 through their ISP.

The selection process for each System User for particular desired news content may be based on System User-based criteria. For example, the System User may base news content selection on news content the System User has viewed in the past, a particular rating the System User has assigned to specific news content, queries that the System User has performed in the past, news content viewed by similarly situated System Users, or predetermined topics of interest. Although, certain selection criteria have been set forth herein, is understood that other selection criteria may be used and still be within the scope of the present invention.

Once the news content of interest has been selected by the System Users using their respective selection criteria, each System User optionally may prioritize (filter or rank) the news content of interest based on the System User's individually based criteria. For example, prioritization may be based on the “freshness” of the news content or the “particular relevance” of the news content to the specified interests of the System User. The news content may also be prioritized using basic search engine queries or by restricting the list to news content available on particular set of sites or types of sites and still be within the scope of the present invention. In referring to the types of sites according to the present invention, it may include, but not be limited to, blogs, mainstream media, forums, or message boards and still be within the scope of the present invention. It is understood that other types of prioritization may be used and still be within the scope of the present invention, such restrictions based on language or geographic references. For purposes of explanation, it is understood that in referring to “selection criteria” it will include “prioritization criteria;” however, the present invention is fully operational without “prioritization criteria” being part of the “selection criteria.”

Following the selection of the news content of interest by each System User, the selection criteria or the results of the application of the selection criteria is sent to central system server 110 in the form of a “request.” For example, the request that is sent to the central system server 110 may include, but not be limited to, topics, search queries, lists of web sites, types of web sites, publication dates or constraints, relevancy, or other factors or constraints that determine how and when news content is to be transmitted, displayed, ranked, or consumed.

It is further understood any input by the System User that results in a request being transmitted to central system server 110 will be viewed by the present invention to be selection criteria. However, it is understood that other selection criteria may be used than has been described herein and still be within the scope of the present invention.

Central system 110 will transmit the requests received from each System User to system database 112 for storage and processing. System database 112 will process this information by updating the system database to reflect the number of System Users that have selected specific news content as news content of interest based on the selection criteria. When new news content is discovered that may or may not relate to a specific System User's previous requests, system database 112 will receive notice of this new news content through the central system server and compute the demand count for that news content based on the stored selection criteria of each System User. The last login time of each System User may be used to additionally weight the computed demand count, so the less active System Users will have less influence on the demand count for news content.

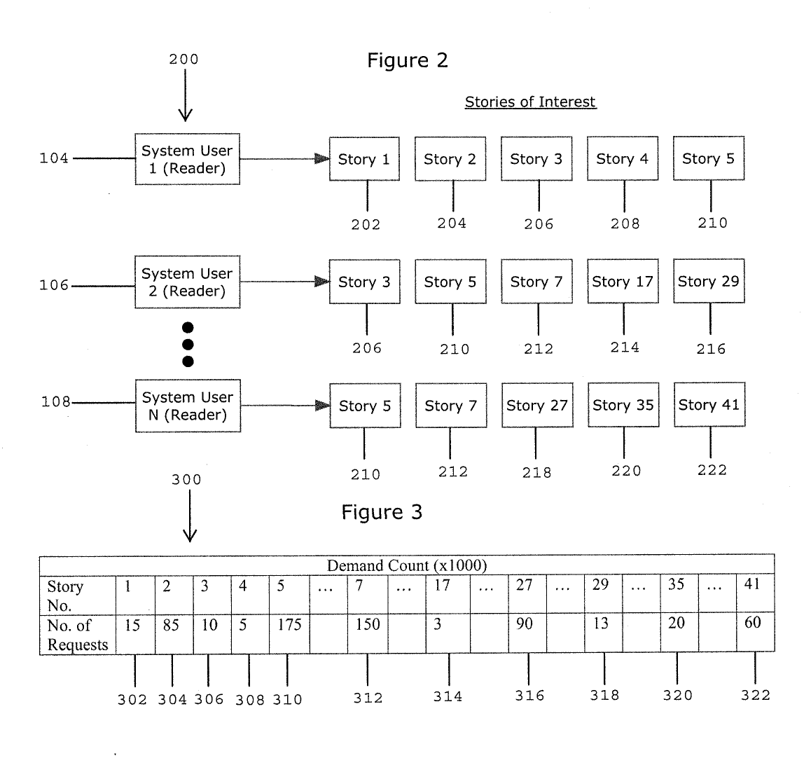

In processing the selection criteria for news content from System Users 1 to N, system database 112 will generate a “demand count.” This demand count may be based on the actual requests based on selection criteria from System Users or predicted to be received from System Users, as system settings by System Users, e.g., a System User that is a webmaster. This will be described in greater detail with reference to FIGS. 2 and 3. This demand count indicates the number of System Users that have chosen particular news content as news content of interest.

Preferably central system server 110 will upload the demand count to the Internet 114 where it will be displayed on a website, such as website 116. Website 116 is an example of a location where the demand count may be displayed for presenters, such as Presenter 1 at 128, Presenter 2 at 130, and Presenter 3 at 132 to view for consideration to create high quality audio or video presentations for news content.

Again referring to FIG. 1, Presenters 1, 2, and 3 at 128, 130, and 132, respectively, are individuals with access to the Internet who would like to participate in the creation of presentations of news content. Each presenter has an opportunity to create audio or video presentation for any specific news content. Preferably, these presentations will be of the quality of the nightly news on television or featured programming on radio, such as for example, National Public Radio or BBC audio broadcast presentations.

Presentations that are created by presenters will be uploaded to the central system server. The uploaded presentations may be in any language desired by the presenter. The presentations from the various presenters may be directed to the same or different news content. As such, this provides a crowdsourcing element for any particular news content.

Each presenter shown in FIG. 1 refers to a presenter or that presenter's computer-based system that is in wired or wireless communication with the Internet. Preferably, each presenter's computer-based system would include at least a processor, display screen, storage medium, input subsystem, and audio subsystem.

If a presenter obtains permission from a publisher of particular news content to reproduce news contents, or reproduce and distribute a derivative work of such news content in the form of an oral or a visual presentation, the presenter can create and upload the presentation to a website, such as, for example, website 118 on Internet 114. Systems Users may then view or listen to the presentations through Internet access, or download the presentation to a replay device, such as an iPod, a cellular telephone, a PDA, a computer, or other multimedia device. This download may be manual or automatic and still be within the scope of the present invention.

As the published news content was selected based on the selection criteria in a manner described above, System Users may vote on and rank presentations and presenters based on each presenter's presentation. For example, these rankings by the System Users may indicate which presenter(s) has (have) the highest ranking for his/her presentation(s) of particular news content. Accordingly, this ranking would indicate which presenters are preferred for particular news content among the public. However, a System User does not have to select a preferred presenter for particular news content presentations but may make this selection based on a presenter giving the presentation, or default to certain presenters based on preference setting made by the System User.

If a System User selects a presenter that is not necessarily the preferred presenter based on rankings, such a System User may use certain other criteria for this selection. The selection criteria may include, but not be limited to, the presenter's talking speed, loudness of voice, vocal frequency range, professionalism, educational background, accents, or translation quality.

Advertisers may desire to have advertisements associated with certain presentations that are provided to System Users through website 118. When this is the case, the presenters and publishers may share in the associated advertising revenues. The preferred method of revenue sharing will be described in greater detail subsequently.

With regard to a presenter's right to create and distribute presentations that relate to news content of a news content publisher or owner, the presenter must obtain the publisher's or owner's authorization before distribution of the presentation. If this authorization is obtained, the presenter would be free to distribute the presentation subject to the terms and conditions agreed to with the publisher or owner. The publisher or owner of the news content may provide this authorization within the news content by embedding meta tags in such news content that authorizes redistribution. Publishers or owners of news content also may maintain whitelists or blacklists of presenters for each particular news content story, or for the whole website based on compliance with, or violation of, the publisher's or owner's redistribution rights.

Referring to FIGS. 2 and 3, generation of the demand count will be described in greater detail. Referring to FIG. 2, generally at 200, System User 1 is shown at 104, System User 2 is shown at 106, and System User N is shown at 108. Each of these System Users is shown associated with certain news content, in the form of news stories, that each has selected as stories of interest based on the selection criteria that includes prioritization criteria. In FIG. 2, what is shown as stories for each System User is understood to have resulted from each System User's selection criteria.

In FIG. 2, there are five stories of interest shown based on the selection criteria for each System User; however, it is understood that there may be more or less than five stories associated with each System User and there does not have to be an equal number of stories associated with each System User and still be within the scope of the present invention.

Demand count may be dependent on a variety of criteria. For example, demand count may be dependent on a publication date, a number of comments from System Users or web users, a number of incoming hyperlinks from System Users or web users, or a popularity rating by System Users or web users. It is understood that other dependencies are possible and still be within the scope of the present invention.

The selection process for the stories for each System User may be based on a System User's individual criteria, such as news content the System User has viewed in the past, a particular rating the System User has assigned to specific news content, queries that the System User has performed with regard to news content, news content viewed by other similarly situated System Users, or predetermined topics of interest. As stated, these criteria are just exemplary of the criteria a System User may use for selection of news content. As such, other selection methods may be used and still be within scope of the present invention.

Again referring to FIG. 2, the System Users' selected and prioritized news stories based on selection criteria (requests) are shown. In priority order, System User 1 at 104 selected Story 1 at 202, Story 2 at 204, Story 3 at 206, Story 4 at 208, and Story 5 at 210. Similarly, in priority order, System User 2 at 106 selected Story 3 at 206, Story 5 at 210, Story 7 at 212, Story 17 at 214, and Story 29 at 218. Finally, similarly, in priority order, System User N at 108 selected Story 5 at 210, Story 7 at 212, Story 27 at 216, Story 35 at 220, and Story 41 at 222. It is understood that the priority rankings may be different and still be within the scope of the present invention.

Once selections are made by System Users 1 to N, this selection information is uploaded directly to central system server 110 or indirectly to central system 110 through the Internet 114 through a wired or wireless connection. Central system server 110 will transmit the selection information to system database 112 which will process the information to update the demand count files shown in FIG. 3.

Referring to FIG. 3, generally at 300, system database 112 will include at least storage space that will store the number of selections for any particular story (news content) by the various System Users. The table of information shown in FIG. 3 is meant to be representative of information that may be stored in system database 112 for at least 41 news stories (news content). However, it is understood that there may be selection information stored in system database 112 for more or less than 41 stories and still be within the scope of the present invention.

As shown in the table in FIG. 3, Story 1 at 302 had 15,000 selections, Story 2 at 304 had 85,000 selections, Story 3 at 306 had 10,000 requests, Story 4 at 308 at 5,000 requests, Story 5 at 310 had 175,000 selections, Story 7 at 312 had 150,000 selections, Story 17 at 314 had 3,000 selections, Story 27 at 316 had 90,000 selections, Story 29 at 318 had 13,000 selections, Story 35 at 320 had 20,000 selections, and Story 41 at 322 had 60,000 selections. These selections signify the demand count.

The demand count as represented in FIG. 3 would be made available on a website, such as website 116 (FIG. 1) for presenters, such as Presenter 1 at 128, Presenter 2 at 130, and Presenter 3 at 132, to view. These presenters may decide to prepare audio or video presentations based on the most requested news content indicated in the demand count or news content of interest to the presenter for uploading to central system 110. The presenters may use other criteria for making the decision to prepare presentations and still be within the scope of the present invention.

If, for example, Presenter 1 at 128, Presenter 2 at 130, and Presenter 3 at 132 consider preparing presentations based on the highest demand count, then each would prepare a presentation based on Story 5 at 310 (FIG. 3) since there were 175,000 selections for this news content. Since each presenter would prepare his/her own presentation directed to the news content of Story 5, there would be a crowdsourcing element to the news content of Story 5.

Each of the three System Users would have the ability to rate the presentations provided by each of the three Presenters for Story 5. Numerical rating data relating to presenters and their presentations with respect to this news content would be collected and stored by central system server 110, and posted for review by all System Users and generally for Internet users at website 116. The information relating to the review of presenters and presentations by System Users provides a crowdsourcing evaluation of the presenters and their presentations.

As discussed briefly above, advertisers may select topics or news content for which they desire to associate their advertisements. Advertisers may also desire to localize their advertisements to very specific news content or particular presenters. Other filtering and selection processes may be used and still be within the scope of this present invention. Preferably, however, advertisers will associate advertisements with news content presentations on particular topics and the advertising revenues will be shared according to co-pending U.S. patent application Ser. No. 12/061,605, filed Apr. 2, 2008, which is incorporated herein by reference.

Accordingly, to the preferred method of revenue sharing, the probability of an advertiser having its advertisement associated with specific news content or topic is directly proportional to how much the advertiser has paid relative to all the other advertisers for that news content topic. Particular news content is paid for based on its share of the total number of news content presented on a particular topic (which may be defined as all news content matching a query definitive for that topic). For example, for the topic “Zebras,” there may be just two presentations. Presentation 1 for the particular story was delivered to 100 System Users and Presentation 2 was delivered to 200 System Users. As such, Presentation 1 would make ⅓ of the total ad revenue that was pledged to that topic, while Presentation 2 would make ⅔. With regard to particular news content, the revenue is distributed between the publisher and the presenter(s), and the payout ratio is determined according to (1) negotiations, (2) a formula by the publisher, or (3) independently by the publisher. The foregoing is the preferred method of revenue-sharing for advertisements associated with presentations; however, other methods of revenue-sharing may be used and still be within the scope of the present invention.

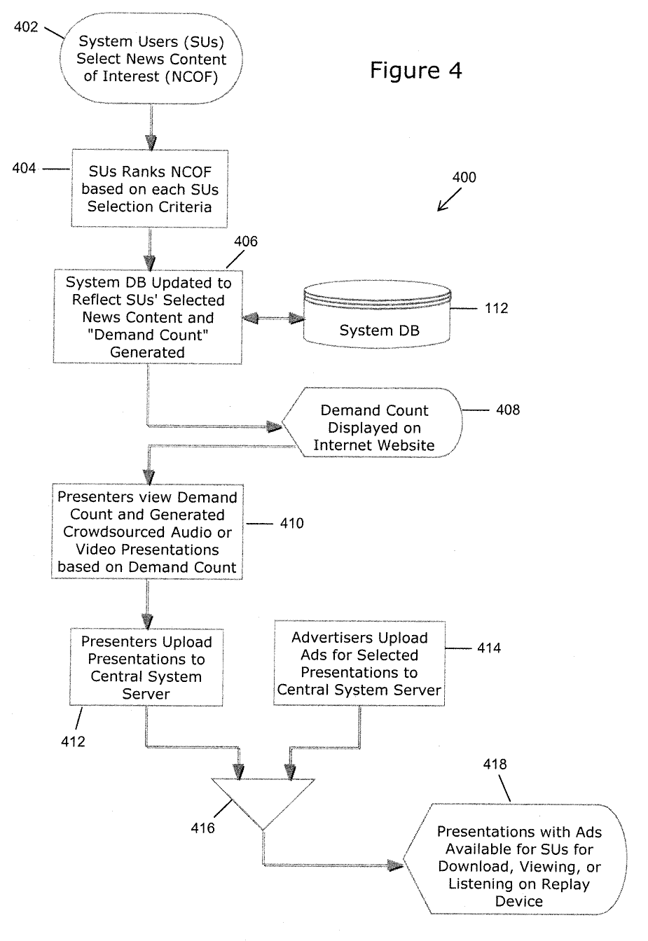

Referring to FIG. 4, a flow diagram according to the method of the present invention is shown generally at 400. At 402, System Users will select one or more news content of interest for which there is a desire to have a high quality audio and/or video presentations made based on selection criteria. At 404, each System User prioritizes the news content of interest based on that System User's selection criteria. This selection criteria will be personal to each System User. The selection criteria for selecting news content of interest provides crowdsourcing with respect to available news content from the number of news content publishers.

After each of the System Users selects (and optionally prioritizes) his/her news content of interest based on selection criteria, the corresponding criteria, or the news content it defines, is transmitted to central system server. The central system server at 406 may transmit the selection criteria or news content it defines to system database 112 for updating the demand count. This demand count will then be transmitted to an Internet website for display as shown at 408.

At 410, potential presenters who are capable of converting the news content of interest into high quality audio or video presentations will view the demand count, for example at website 408, to see which news content has been selected the most numerically by the System Users. Although not obligated to do so, potential presenters likely would select news content with the most demand as evidenced by the demand count information for preparation of audio and/or video presentations.

After one or more presenters (with appropriate authorization from the news content publisher) have prepared audio and/or video presentations, the presentations are uploaded to the central system server at 412. At 416, the presentations are merged with advertising advertisements that advertisers desire to have associated with certain news content presentations. At 418, the presentations with imbedded advertisements are posted on an Internet website for downloading, viewing, or listening to by System Users.

System Users can provide feedback with respect to the presentations by presenters which will result in crowdsourced ranking of presenters and presentations. Moreover, the publishers of news content and presenters who develop presentations respect to such news content may share in the advertising revenues that have been paid by advertisers to have their advertisements associated with specific presentations of news content.

It is understood that the elements of the system of the present invention may be connected electronically by wired or wireless connections and still be within the scope of the present invention.

The embodiments or portions thereof of the system and method of the present invention may be implemented in computer hardware, firmware, and/or computer programs executing on programmable computers or servers that each includes a processor and a storage medium readable by the processor (including volatile and non-volatile memory and/or storage elements). Any computer program may be implemented in a high-level procedural or object-oriented programming language to communicate within and outside of computer-based systems.

Any computer program may be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the embodiments. The embodiments or portions thereof, may also be implemented as a machine-readable storage medium, configured with a computer program, where, upon execution, instructions in the computer program cause a machine to operate to perform the functions of the embodiments described above.

The embodiments or portions thereof, of the system and method of the present invention described above may be used in a variety of applications. Although the embodiments or portions thereof, are not limited in this respect, the embodiments or portions thereof, may be implemented with memory devices in microcontrollers, general purpose microprocessors, digital signal processors (DSPs), reduced instruction-set computing (RISC), and complex instruction-set computing (CISC), among other electronic components. Moreover, the embodiments, or portions thereof, described above may also be implemented using integrated circuit blocks referred to as main memory, cache memory, or other types of memory that store electronic instructions to be executed by a microprocessor or store data that may be used in arithmetic operations.

The descriptions are applicable in any computing or processing environment. The embodiments, or portions thereof, may be implemented in hardware, software, or a combination of the two. For example, the embodiments, or portions thereof, may be implemented using circuitry, such as one or more of programmable logic (e.g., an ASIC), logic gates, a processor, and a memory.

The terms and expressions that are employed herein are terms or descriptions and not of limitation. There is no intention in the use of such terms and expressions of excluding the equivalents of the feature shown or described, or portions thereof, it being recognized that various modifications are possible within the scope of the invention as claimed.

1. A computer-implemented system for presenting news content in an audio or video form to System Users, comprising:
a plurality of system user news content (SUNC) computer-based devices that are in electronic communication with a central network, with each SUNC computer-based device including at least a programmable processor, storage medium, viewing screen, input subsystem, audio subsystem, and central network connection subsystem for selecting not prioritizing, news content viewing on the central network;
a central system server that is in electronic communication with the plurality of SUNC computer-based devices;
a system database that is in electronic communication with the central system server for calculating and storing a demand count based on news content requests, received, or predicted to be received from the plurality of SUNC computer-based devices for specific news content from one or more news content publishers;
the central network that is in electronic communication with SUNC computer-based devices, the central system server, at least one publisher computer-based system, and at least two presenter computer-based systems, with the central network for displaying the demand count, making news content available for system user viewing, and displaying presenter audio or video presentations;
the at least one publisher computer-based system for electronically transmitting to the central network news content for general viewing on the central network; and
the presenter computer-based systems for electronically communicating converted news content in the form of audio or video presentations to the central system server via the central network.

2. The system as recited in claim 1, wherein the central network includes the Internet.

3. The system as recited in claim 1, wherein the central network includes an intranet.

4. The system as recited in claim 1, wherein the demand count for news content includes being dependent on a publication date, a number of comments, a number of incoming hyperlinks, or a popularity ranking of such news content.

5. The system as recited in claim 1, wherein the presenter computer-based systems each include at least a programmable processor, storage medium, viewing screen, input subsystem, and audio subsystem.

6. The system as recited in claim 1, wherein the publisher computer-based system includes at least a programmable processor, storage medium, viewing screen, input subsystem, and audio subsystem.

7. The system as recited in claim 1, wherein news content includes content made available on the central network that includes, but is not limited to, news content.

8. A computer implemented method for generating crowdsourced audio or video presentations directed to news content, comprising the steps of:
(A) a plurality of news content publishers electronically providing news content on a central network for general viewing;
(B) a plurality of system users in electronic communication with the central network at least viewing news content made available on the central network by the plurality of news content publishers at step (A);
(C) each of the plurality of system users selecting specific news content viewed at step (B) according to each system user's selection criteria, and electronically transmitting such selection criteria, or the news content such selection criteria defines, to a central system server with a database electronically connected thereto, with the database for calculating and storing an actual or predicted demand count for specific news content made available on the central network at step (A);
(D) the central system server electronically transmitting the demand count to the central network for viewing by presenters of audio or video presentations;
(E) presenters selecting news content to convert to audio or video presentations based on presenter selection criteria, and creating and transmitting such audio or video presentations to the central network for at least viewing or listening to by system users; and
(F) system users viewing or listening to presentations on the central network based on system user selection criteria.

9. The method as recited in claim 8, wherein the demand count for news content includes being dependent on a publication date, a number of comments, a number of incoming hyperlinks, or a popularity ranking of such news content.

10. The method as recited in claim 8, wherein the system user selection criteria at step (C) includes previously viewed news content, readings assigned to news content, queries or rankings made by the system user, or topics of interest for system user.

11. The method as recited in claim 8, wherein filtering or ranking according to step (C) includes freshness of the news content or relevancy of the news content.

12. The method as recited in claim 8, wherein filtering or ranking according to step (C) includes search engine queries or specific types of sources of news content.

13. The method as recited in claim 12, wherein specific types of sources of news content include electronic-based blogs, mainstream media, forums, or message boards.

14. The method recited in claim 8, wherein transmitting audio or video presentations to the central network at step (E) includes transmitting the audio or video presentation to the central network through the central system server.

15. The method as recited in claim 8, wherein presenter selection criteria to convert news content to audio or video presentations at step (E) include selecting news content according to actual or predicted demand count rankings.

16. The method as recited in claim 8, wherein presenter selection criteria to convert news content to audio or video presentations at step (E) include selecting news content according to a topic of the news content.

17. The method as recited in claim 8, the method further includes associating advertising with presentations transmitted to the central network at step (E).

18. The method as recited in claim 17, advertisers pay advertising revenues with respect to advertising associated with presentations transmitted to the central network at step (E).

19. The method recited in claim 8, wherein system users rank presenters of presentations viewed and listened to at step (F).

20. A computer implemented method for generating crowdsourced audio or video presentations directed to news content, comprising the steps of:
(A) a plurality of news content publishers electronically providing news content on a central network for general viewing;
(B) a plurality of system users in electronic communication with the central network at least viewing news content made available on the central network by the plurality of news content publishers at step (A);
(C) each of the plurality of system users selecting specific news content viewed at step (B) according to each system user's selection criteria, and electronically transmitting that system user such selection criteria, or the news content such selection criteria defines, to a central system server with a database electronically connected thereto, with the database for calculating and storing an actual or predicted demand count for specific news content made available on the central network at step (A);
(D) the central system server electronically transmitting the demand count to the central network for viewing by presenters of audio or video presentations;
(E) presenters selecting news content to convert to audio or video presentations based on presenter selection criteria, and creating and transmitting such audio or video presentations to the central system server;
(F) presenters obtaining publisher permission to distribute audio or video presentations of publisher-owned news content;
(G) the central system server transmitting audio or video presentations to the central network for at least viewing or listening to by system users for which publisher permission has been obtained at step (F); and
(H) system users viewing or listening to presentations on the central network based on system user criteria.

21. The method as recited in claim 20, wherein the demand count for news content includes being dependent on a publication date, a number of comments, a number of hyperlinks, or a popularity ranking of such news content.

22. The method as recited in claim 20, wherein the system user selection criteria at step (C) includes previously viewed news content, readings assigned to news content, queries made by the system user, or topics of interest for system user.

23. The method as recited in claim 20, wherein filtering or ranking according to step (C) includes freshness of the news content or relevancy of the news content.

24. The method as recited in claim 20, wherein filtering or ranking according to step (C) includes search engine queries or specific types of sources of news content.

25. The method as recited in claim 24, wherein specific types of sources of news content include electronic-based blogs, mainstream media, forums, or message boards.

26. The method as recited in claim 20, wherein presenter selection criteria to convert news content to audio or video presentations at step (E) include selecting news content according to actual or predicted demand count rankings.

27. The method as recited in claim 20, wherein presenter selection criteria to convert news content to audio or video presentations at step (E) include selecting news content according to a topic of the news content.

28. The method as recited in claim 20, the method further includes associating advertising with presentations transmitted to the central network at step (G).

29. The method as recited in claim 28, advertisers pay advertising revenues with respect to advertising associated with presentations transmitted to the central network at step (G).

30. The method recited in claim 20, wherein system users rank presenters of presentations viewed and listened to at step (H).
